(19) United States
(12) Patent Application Publication
(10) Pub. No.: US 2021/0117306 A1
(43) Pub. Date: Apr. 22, 2021

(54) SYSTEMS AND METHODS FOR PROBING VIRTUAL, WEB AND SAAS APPLICATIONS

(71) Applicant: Citrix Systems, Inc., Burlington, MA (US)

(72) Inventors: Priyanka Somashekar, Bangalore (IN); Vikramjeet Singh Sandhu, Bangalore (IN); Mudit Mehrotra, Bangalore (IN)

(21) Appl. No.: 16/660,218

(22) Filed: Oct. 22, 2019

(51) Int. Cl. G06F 11/36

(52) U.S. Cl. CPC G06F 11/3612; G06F 11/3644; G06F 11/3616; G06F 11/3664

(57) ABSTRACT

Described embodiments provide a method, computer program product, and computer system for creating, by a client device, an application probe, the application probe configured to monitor at least one attribute of an application accessible via the client device. The client device may receive data indicative of the at least one attribute of the application in response to the application being monitored by the application probe. The client device may determine a value for the at least one attribute based upon, at least in part, the received data. The client device may compare the determined value with a threshold to identify an issue with the application. The client device may provide an indication to a computing device in response to the comparison of the determined value with the threshold, so as to enable the computing device to modify operation of the application to address the issue.

### BACKGROUND

An administrator may desire to know about any problems that could be experienced by a user prior to the user actually experiencing such a problem. For example, if an application endpoint is not available when the user attempts to access it, a poor user experience has occurred, and the user may then contact the administrator to fix the issue.

### BRIEF SUMMARY OF DISCLOSURE

In one example implementation, a method, performed by one or more computing devices, may include but is not limited to creating, by a client device, an application probe, the application probe configured to monitor at least one attribute of an application accessible via the client device. The client device may receive data indicative of the at least one attribute of the application in response to the application being monitored by the application probe. The client device may determine a value for the at least one attribute based upon, at least in part, the received data. The client device may compare the determined value with a threshold to identify an issue with the application. The client device may provide an indication to a computing device in response to the comparison of the determined value with the threshold, so as to enable the computing device to modify operation of the application to address the issue.

One or more of the following example features may be included. The application may be one of a software as a service (SaaS) application, a virtual application, a published application, and a hosted shared desktop. The at least one attribute may include one or more of logon duration, application launch duration, and latency. The application may be accessible by the client device through one of a loaded environment and an unloaded environment. One or more user based actions of a user may be verified for the application based upon the received data. The one or more user based actions may include authenticating the user to access the application with the application. The one or more user based actions may include navigating through the application.

In another example implementation, a computing system may include one or more processors and one or more memories configured to perform operations that may include but are not limited to creating, by a client device, an application probe, the application probe configured to monitor at least one attribute of an application accessible via the client device. The client device may receive data indicative of the at least one attribute of the application in response to the application being monitored by the application probe. The client device may determine a value for the at least one attribute based upon, at least in part, the received data. The client device may compare the determined value with a threshold to identify an issue with the application. The client device may provide an indication to a computing device in response to the comparison of the determined value with the threshold, so as to enable the computing device to modify operation of the application to address the issue.

One or more of the following example features may be included. The application may be one of a software as a service (SaaS) application, a virtual application, a published application, and a hosted shared desktop. The at least one attribute may include one or more of logon duration, application launch duration, and latency. The application may be accessible by the client device through one of a loaded environment and an unloaded environment. One or more user based actions of a user may be verified for the application based upon the received data. The one or more user based actions may include authenticating the user to access the application with the application. The one or more user based actions may include navigating through the application.

In another example implementation, a computer program product may reside on a computer readable storage medium having a plurality of instructions stored thereon which, when executed by one or more processors, may cause the one or more processors to perform operations that may include but are not limited to creating, by a client device, an application probe, the application probe configured to monitor at least one attribute of an application accessible via the client device. The client device may receive data indicative of the at least one attribute of the application in response to the application being monitored by the application probe. The client device may determine a value for the at least one attribute based upon, at least in part, the received data. The client device may compare the determined value with a threshold to identify an issue with the application. The client device may provide an indication to a computing device in response to the comparison of the determined value with the threshold, so as to enable the computing device to modify operation of the application to address the issue.

One or more of the following example features may be included. The application may be one of a software as a service (SaaS) application, a virtual application, a published application, and a hosted shared desktop. The at least one attribute may include one or more of logon duration, application launch duration, and latency. The application may be accessible by the client device through one of a loaded environment and an unloaded environment. One or more user based actions of a user may be verified for the application based upon the received data. The one or more user based actions may include authenticating the user to access the application with the application. The one or more user based actions may include navigating through the application.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1A is an example diagrammatic view of an example network environment according to one or more example implementations of the disclosure;

FIG. 1B is an example diagrammatic view of an example cloud computing environment according to one or more example implementations of the disclosure;

FIG. 2 is an example diagrammatic view of a computing device of FIG. 1 according to one or more example implementations of the disclosure;

FIG. 3 is an example flowchart of a probe process according to one or more example implementations of the disclosure;

FIG. 4 is an example diagrammatic view of a probe environment according to one or more example implementations of the disclosure; and

FIG. 5 is an example diagrammatic view of a probe endpoint according to one or more example implementations of the disclosure.

Like reference symbols in the various drawings may indicate like elements.

### DETAILED DESCRIPTION

Generally, an administrator may desire to check the health and performance of all or at least the most critical applications published within the administrator's environment. For instance, the administrator may desire to know about any problems that could be experienced by a user of the environment prior to the user actually experiencing such a problem, which may result in the user contacting the administrator to correct it. As an example, if an application endpoint is not available when the user attempts to access it, and the user may then contact the administrator to fix the issue. As such, a probe may be created by the administrator to verify whether or not the application endpoint is available. However, such a probe only verifies whether or not the application endpoint is available, is not capable of being used to test for a software as a service (SaaS) application or a virtual application, and is also not capable of enabling the administrator to verify other aspects of the user's potential experience, such as whether the user is able to be authenticated, other user based actions, or the health and performance of the environment running the application.

Accordingly, the present disclosure may enable a probe to not only determine whether a published resource (e.g., SaaS application, virtual application, published application, a hosted shared desktop (HSD), etc.) is available, but also to check the health and performance of all or at least the most critical applications published within the administrator's environment. For example, the probe may determine what are the values of monitored attributes (e.g., logon duration, application launch duration, round-trip time/latency) in an unloaded environment (e.g., off-hours on a weekend with low traffic) or in peak loaded environment (e.g., late morning on a Tuesday with heavy traffic), to help better understand the “normal” values for the environment, which may then be used to help determine alert threshold values, and which may help the administrator assess the real application health and accordingly, in case of failures or low network resources, enable the administrator to take proactive measures to fix problems or minimize disruption to the client. For example, if the user comes in at 8 am and probe runs the test at 4 am, the administrator may find out the problems earlier than any user may experience them, to provide the administrator with some time to try to remedy and contain any disruption. Moreover, as will be discussed below, the present disclosure may enable a probe to use a user account (e.g., an actual user account or a test account) to schedule periodic launch for a select set of published resources. The probe may then determine whether a resource is available for the end user, if a user is able to authenticate to the application, and/or if the user is able to navigate after the authentication. For instance, the present disclosure may enable obtaining detailed information on the authentication stage and post authentication as well, where data packets may be captured and replayed, and example user actions, such as mouse clicks and keyboard strokes, may be captured and replayed on probed applications.

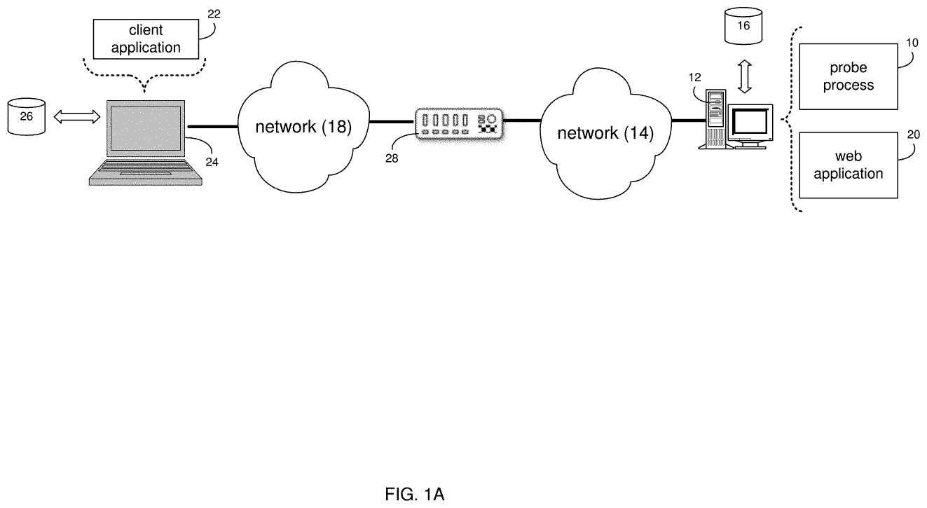

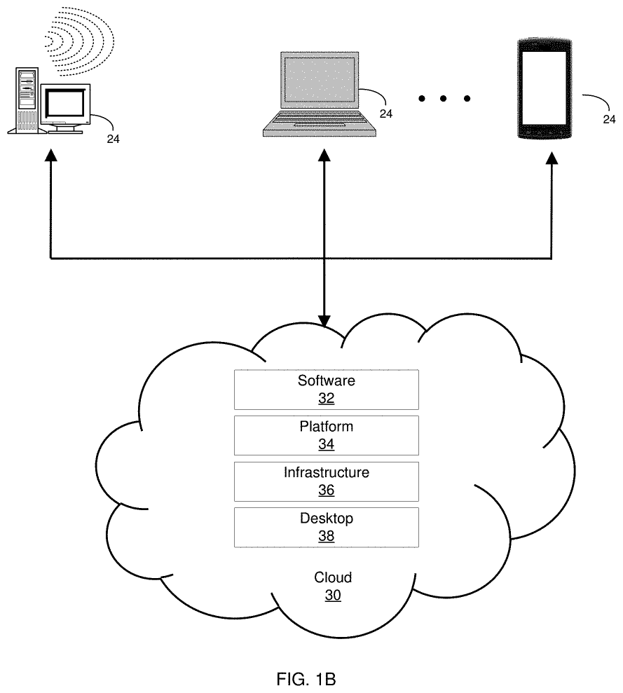

Referring now to the example implementation of FIG. 1A, there is shown probe process 10 that may reside on and may be executed by a computer (e.g., one or more remote machines also referred to as computer 12), which may be connected to a network (e.g., network 14) (e.g., the internet or a local area network). In some implementations, the instruction sets and subroutines of probe process 10, which may be stored on storage device, such as storage device 16, coupled to computer 12, may be executed by one or more processors and one or more memory architectures included within computer 12. In some implementations, probe process 10 may be a component of a data store, a standalone application that interfaces with the above noted data store and/or an applet/application that is accessed via client application 22. In some implementations, the above noted data store may be, in whole or in part, distributed in a cloud computing topology. In this way, computer 12 and storage device 16 may refer to multiple devices, which may also be distributed throughout the network. Computer 12 (e.g., via probe process 10) may execute, operate or otherwise provide an application that may be any one of the following: software; a program; executable instructions; a virtual machine; a hypervisor; a web browser; a web-based client; a client-server application; a thin-client computing client; an ActiveX control; a Java® applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. In some implementations, probe process 10 and/or web application 20, such as a SaaS application, may be accessed via one or more of client applications to facilitate the transfer of data and/or information among computer 12 and client electronic device 24 via network 14 and/or network 18. Client electronic device 24 (and/or computer 12) may include, but are not limited to, a personal computer, a mobile computing device such as a laptop computer, a smart/data-enabled, cellular phone, a notebook computer, and a tablet, a television, a smart speaker, an Internet of Things (IoT) device, a media (e.g., audio/video, photo, etc.) capturing and/or output device, an audio input and/or recording device (e.g., a microphone), a storage system (e.g., a Network Attached Storage (NAS) system, a Storage Area Network (SAN)), a server computer (e.g., a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality), a series of server computers, a server farm/datacenter, a mainframe computer, a computing cloud, or any other network enabled device. In some implementations, each of the aforementioned may be generally described as a computing device, and may also be referred to as a local machine, a client, a client node, a client computer, a client device, a client electronic device, a computing device, a computer, an endpoint, or an endpoint node, herein referred to as either a client electronic device or a computer. In some implementations, the client electronic devices 24 may have the capacity to function as a client node seeking access to resources provided by computer 12. The client electronic devices can be further configured to host resources accessible by computer 12.

In certain implementations, the client electronic devices 24 and/or computer 12 may be a physical or virtual device. In many implementations, the client electronic devices 24 and/or computer 12 may be any device capable of performing operations, such as a dedicated processor, a portion of a processor, a virtual processor, a portion of a virtual processor, portion of a virtual device, or a virtual device. In some implementations, a processor may be a physical processor or a virtual processor. The client electronic devices 24 and/or computer 12 may be a virtual machine that may provide to a user of the client electronic device access to a computing environment. The virtual machine may be managed by, for example, a hypervisor, a virtual machine manager (VMM), or any other hardware virtualization technique. In some implementations, a virtual processor may correspond to one or more parts of one or more physical processors. In some implementations, the instructions/logic may be distributed and executed across one or more processors, virtual or physical, to execute the instructions/logic. The client electronic devices 24 and/or computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the client electronic devices 24 and/or computer 12 may include storage devices (e.g., storage device 16, 26) such as: an electrical connection having one or more wires; a portable computer diskette; a hard disk drive; all forms of flash memory storage devices including an erasable programmable read-only memory (EPROM); a tape drive; an optical drive/fiber; a Redundant Array of Independent Disks (RAID) array (or other array); a random access memory (RAM); a read-only memory (ROM); a portable compact disc read-only memory (CD-ROM); a digital versatile disk (DVD); a static random access memory (SRAM); a memory stick; a floppy disk; a mechanically encoded device; a media such as those supporting the internet or an intranet; a magnetic storage device; or combination thereof. In some implementations, the client electronic devices 24 and/or computer 12 may include a data store, such as a database (e.g., relational database, object-oriented database, triplestore database, etc.) and may be located within any suitable memory location (e.g., storage device 16 coupled to computer 12). In some implementations, the storage devices 16 and 26 may be communicatively coupled to the client electronic devices 24 and/or computer 12 to store data, metadata, or other information to facilities operation of the present disclosure.

In some implementations, the client electronic devices 24 and/or computer 12 may be communicatively coupled to the data store so that data, metadata, information, etc. described throughout the present disclosure may be stored and accessed. In some implementations, the client electronic devices 24 and/or computer 12 may provide multi-user access to one or more databases, such as the above noted relational database. In some implementations, the data store may also be a custom database, such as, for example, a flat file database or an XML database. In some implementations, any other form(s) of a data storage structure and/or organization may also be used.

In some implementations, computer 12 may execute a web application (e.g., web application 20), examples of which may include, but are not limited to, e.g., a SaaS application, a file sharing application, a web conferencing application, a video conferencing application, a voice-over-IP application, a video-over-IP application, an Instant Messaging (IM)/“chat” application, a short messaging service (SMS)/multimedia messaging service (MMS) application, a remote presentation services program or other program that uses a thin-client or a remote-display protocol to capture output generated by an application executing on computer 12 and transmit the output to the client electronic device, or other application that allows for file sharing or even the general viewing of any content (e.g., website content, streaming video games or movies, etc.) on a computing device. An example of a file sharing application may include, but is not limited to, e.g., ShareFile® by Citrix Systems, Inc. of Ft. Lauderdale, Fla.

In some implementations, probe process 10 may be a standalone application, or may be an applet/application/script/extension that may interact with and/or be executed within web application 20, a component of web application 20, and/or one or more of the client applications. In some implementations, web application 20 may be a standalone application, or may be an applet/application/script/extension that may interact with and/or be executed within probe process 10, a component of probe process 10, and/or one or more of the client applications. In some implementations, one or more of the client applications may be a standalone application, or may be an applet/application/script/extension that may interact with and/or be executed within and/or be a component of probe process 10 and/or web application 20. Examples of client applications may include, but are not limited to, e.g., a web conferencing application, a video conferencing application, a voice-over-IP application, a video-over-IP application, an Instant Messaging (IM)/“chat” application, a short messaging service (SMS)/multimedia messaging service (MMS) application, a remote presentation services program or other program that uses a thin-client or a remote-display protocol to capture display output generated by an application executing on computer 12 and transmit the output to the client electronic device 24, or other application that allows for file sharing or even the general viewing of any content (e.g., website content, streaming video games or movies, etc.) on a computing device, a standard and/or mobile web browser, an email application (e.g., an email client application), a textual and/or a graphical user interface, a customized web browser, a plugin, an Application Programming Interface (API), or a custom application. The instruction sets and subroutines of client application 22, which may be stored on storage device 26, coupled to client electronic device 24, may be executed by one or more processors and one or more memory architectures incorporated into client electronic device 24.

In some implementations, one or more of the client applications may be configured to effectuate some or all of the functionality of probe process 10 (and vice versa). Accordingly, in some implementations, probe process 10 may be a purely server-side application, a purely client-side application, or a hybrid server-side/client-side application that is cooperatively executed by one or more of the client applications and/or probe process 10.

In some implementations, one or more of the client applications may be configured to effectuate some or all of the functionality of web application 20 (and vice versa). Accordingly, in some implementations, web application 20 may be a purely server-side application, a purely client-side application, or a hybrid server-side/client-side application that is cooperatively executed by one or more of the client applications and/or web application 20. As one or more of the client applications, probe process 10, and web application 20, taken singly or in any combination, may effectuate some or all of the same functionality, any description of effectuating such functionality via one or more of the client applications, probe process 10, web application 20, or combination thereof, and any described interaction(s) between one or more of the client applications, probe process 10, web application 20, or combination thereof to effectuate such functionality, should be taken as an example only and not to limit the scope of the disclosure.

In some implementations, one or more users may access computer 12 and probe process 10 (e.g., using one or more of client electronic devices) directly through network 14 or through secondary network 18, and probe process 10 may include one or more user interfaces, such as browsers and textual or graphical user interfaces, through which users may access probe process 10. Further, in some implementations, computer 12 may be connected to network 14 through secondary network 18. In some implementations, the client electronic devices 24 may communicate with computer 12 (and vice versa) via intermediary appliance (e.g., appliance 28), which in some implementations may include probe process 10. Appliance 28 may be positioned between networks 14 and 18, and may also be referred to as a network interface or gateway. In some implementations, appliance 28 may operate as an application delivery controller (ADC) to provide users with access to business applications and other data deployed in a datacenter, a cloud environment, or delivered as Software as a Service (SaaS) across a range of computing devices, and/or provide other functionality such as load balancing, etc. In some implementations, multiple appliances 28 may be used, and appliance(s) 28 may be deployed as part of network 14 and/or 18.

In some implementations, one or more client electronic devices 24 and/or computer 12 may be directly or indirectly coupled to networks 14 and/or 18 via a network connection (e.g., a wireless or a hardwired network connection). Further, in some examples, a wireless communication connection may include a wireless access point (WAP). The wireless access point may be, for example, an IEEE 802.11a, 802.11b, 802.11g, 802.11n, 802.11ac, Wi-Fi, RFID, and/or Bluetooth™ (e.g., 802.15) (including Bluetooth™ Low Energy) device that is capable of establishing wireless communication channel (e.g., between client electronic device 24 and the WAP). In some examples, the client electronic devices and/or computer 12 may be wirelessly coupled to a network via wireless communication channel using cellular network/bridge.

In some implementations, networks 14 and/or 18 may include and/or be connected to one or more secondary networks, examples of which may include but are not limited to: a local area network (LAN); a personal area network (PAN); a metropolitan area network (MAN); a wide area network (WAN) or other telecommunications network facility, a primary public network; a primary private network; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of wireless local-area network (WLAN) interconnection (e.g., Near Field Communication (NFC)) may also be used.

In some implementations, various input/output (I/O) requests may be sent from, e.g., client application 22 to, e.g., computer 12 (and vice versa) using network 14 and/or 18. Examples of an I/O request may include but are not limited to, data write requests (e.g., a request that content be written to computer 12) and data read requests (e.g., a request that content be read from computer 12).

Referring also to the example implementation of FIG. 1B, a cloud computing environment is depicted, which may also be referred to as a cloud environment, cloud computing or cloud network. The cloud computing environment may provide the delivery of shared computing services and/or resources to multiple users or tenants. For example, the shared resources and services may include, but are not limited to, networks, network bandwidth, servers, processing, memory, storage, applications, virtual machines, databases, software, hardware, analytics, and intelligence.

In the cloud computing environment, one or more client electronic devices 24 (such as those described above) may be in communication with cloud network 30. Cloud network 30 may include back-end platforms, e.g., servers, storage, server farms or data centers. The users or client electronic devices 24 may correspond to a single organization/tenant or multiple organizations/tenants. More particularly, in one example implementation, the cloud computing environment may provide a private cloud serving a single organization (e.g., enterprise cloud). In another example, the cloud computing environment may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment may provide a hybrid cloud that is a combination of a public cloud and a private cloud. Public clouds may include public servers that are maintained by third parties to the client electronic devices 24 or the enterprise/tenant. The servers may be located off-site in remote geographical locations or otherwise.

The cloud computing environment may provide resource pooling to serve multiple users via client electronic devices 24 through a multi-tenant environment or multi-tenant model with different physical and virtual resources dynamically assigned and reassigned responsive to different demands within the respective environment. The multi-tenant environment may include a system or architecture that may provide a single instance of software, an application or a software application to serve multiple users. In some embodiments, the cloud computing environment may provide on-demand self-service to unilaterally provision computing capabilities (e.g., server time, network storage) across a network for multiple client electronic devices 24. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment may provide an elasticity to dynamically scale out or scale in response to different demands from one or more client electronic devices 24. In some embodiments, the cloud computing environment may include or provide monitoring services to monitor, control and/or generate reports corresponding to the provided shared services and resources.

In some embodiments, the cloud computing environment may provide cloud-based delivery of different types of cloud computing services, such as Software as a service (SaaS) 32, Platform as a Service (PaaS) 34, Infrastructure as a Service (IaaS) 36, and Desktop as a Service (DaaS) 38, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS may include, e.g., AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS may include, e.g., WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS may include, e.g., GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one non-limiting example of a DaaS delivery platform. DaaS delivery platforms may be hosted on a public cloud computing infrastructure such as AZURE CLOUD from Microsoft Corporation of Redmond, Wash. (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

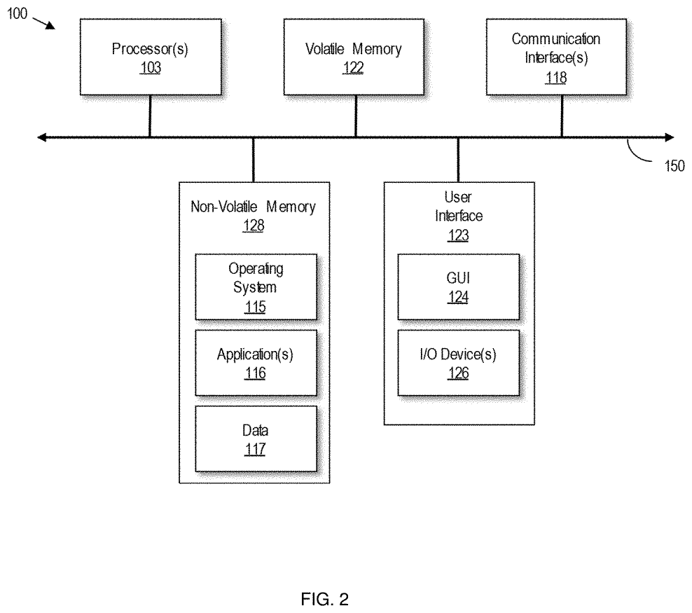

Referring also to the example implementation of FIG. 2, there is shown a block diagram of computing device 100 that may be useful for practicing an implementation of the client electronic devices, appliance 28 and/or computer 12. Computing device 100 may include one or more processors 103, volatile memory 122 (e.g., random access memory (RAM)), non-volatile memory 128, user interface (UI) 123, one or more communications interfaces 118, and a communications bus 150.

Non-volatile memory 128 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

UI 123 may include a graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, and one or more accelerometers, etc.).

Non-volatile memory 128 may store operating system 115, one or more applications 116, and data 117 such that, for example, computer instructions of operating system 115 and/or applications 116 are executed by processor(s) 103 out of volatile memory 122. In some implementations, volatile memory 122 may include one or more types of RAM and/or a cache memory that may offer a faster response time than a main memory. Data may be entered using an input device of GUI 124 or received from I/O device(s) 126. Various elements of computer 100 may communicate via communications bus 150.

Computing device 100 is shown merely as an example client device or server, and may be implemented by any computing or processing environment with any type of machine or set of machines that may have suitable hardware and/or software capable of operating as described herein.

Processor(s) 103 may be implemented by one or more programmable processors to execute one or more executable instructions, such as a computer program, to perform the functions of the system. As used herein, the term “processor” may describe circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some implementations, the processor may be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 103 may be analog, digital or mixed-signal. In some implementations, processor 103 may be one or more physical processors, or one or more virtual (e.g., remotely located or cloud) processors. A processor including multiple processor cores and/or multiple processors may provide functionality for parallel, simultaneous execution of instructions or for parallel, simultaneous execution of one instruction on more than one piece of data.

Communications interfaces 118 may include one or more interfaces to enable computing device 100 to access a computer network such as a Local Area Network (LAN), a Wide Area Network (WAN), a Personal Area Network (PAN), or the Internet through a variety of wired and/or wireless connections, including cellular connections.

In described implementations, computing device 100 may execute an application (e.g., the above-noted client application) on behalf of a user of a client device. For example, computing device 100 may execute one or more virtual machines managed by a hypervisor. Each virtual machine may provide an execution session within which applications execute on behalf of a user or a client device, such as a hosted desktop session. Computing device 100 may also execute a terminal services session to provide a hosted desktop environment. Computing device 100 may provide access to a remote computing environment including one or more applications, one or more desktop applications, and one or more desktop sessions in which one or more applications may execute.

While the present disclosure is described with the use of an enterprise application store (e.g., such as Citrix StoreFront provided by Citrix Systems, Inc. of Ft. Lauderdale, Fla.), it will be appreciated that any enterprise application store (or similar application) may be used without departing from the scope of the present disclosure. An enterprise application store may aid in managing multi-site and multi-version virtual applications and desktop environments.

While the present disclosure is described with the use of a management console (e.g., such as Citrix Director provided by Citrix Systems, Inc. of Ft. Lauderdale, Fla.), it will be appreciated that any management console (or similar application) may be used without departing from the scope of the present disclosure. A management console (e.g., troubleshooting dashboard) may provide real-time and historical health monitoring in virtualization platforms and otherwise, and may allow administrators to control and monitor virtual applications and desktop environments.

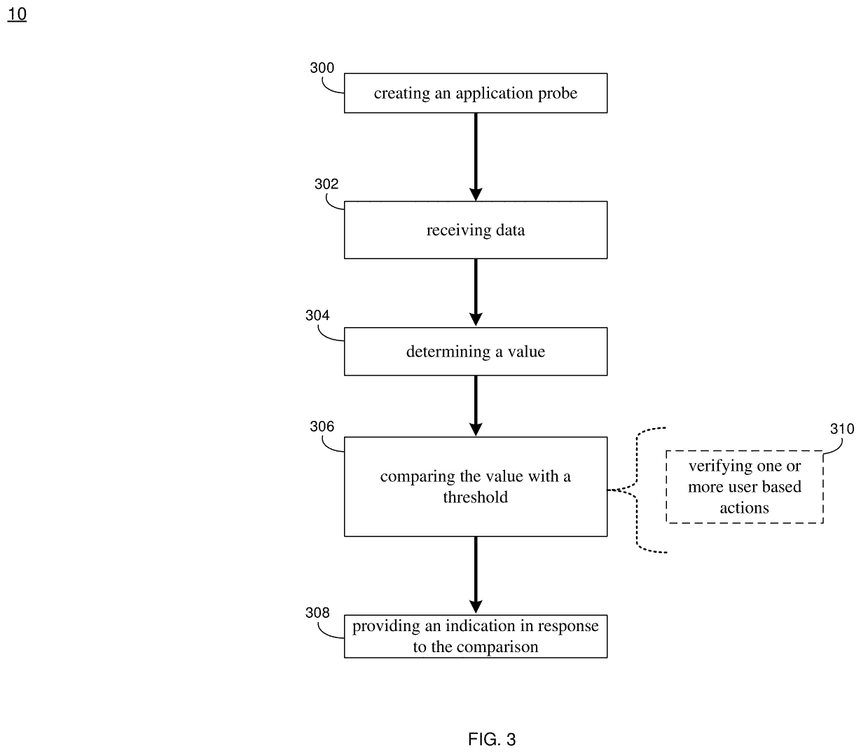

As discussed above and referring also at least to the example implementations of FIGS. 3-5, at block 300, a client device may (e.g., via probe process 10) create an application probe, the application probe configured to monitor at least one attribute of an application accessible via the client device. At block 302, the client device may (e.g., via probe process 10) receive data indicative of the at least one attribute of the application in response to the application being monitored by the application probe. At block 304, the client device may (e.g., via probe process 10) determine a value for the at least one attribute based upon, at least in part, the received data. At block 306, the client device may (e.g., via probe process 10) compare the determined value with a threshold to identify an issue with the application. At block 308, the client device may (e.g., via probe process 10) provide an indication to a computing device in response to the comparison of the determined value with the threshold, so as to enable the computing device to modify operation of the application to address the issue.

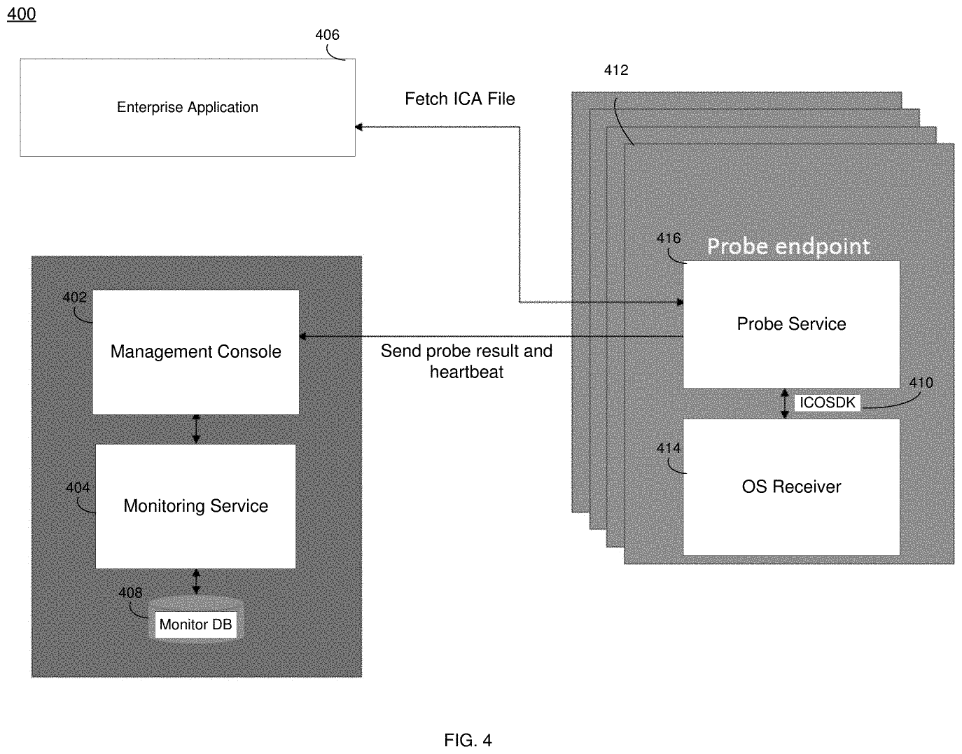

In some implementations, at block 300, a client device may (e.g., via probe process 10) create an application probe, the application probe configured to monitor at least one attribute of an application accessible via the client device. An application probe may generally be described as an action taken or an object used for the purpose of learning something about the state of the network (e.g., an empty message may be sent simply to see whether the destination actually exists), as well as a program or other device inserted in a network for the purpose of monitoring or collecting data about network activity. For instance, probe process 10 may enable (e.g., at management console 402 of FIG. 4) the creation and running of application probes for, e.g., SaaS applications and virtual applications, or other published resources, such as a published application, a hosted shared desktop (HSD), etc. As will be discussed below, the application probes may be used by monitoring service 404 to monitor the health and statistics of the example SaaS applications and virtual applications (as well as other published resources) for various purposes. In some implementations, a user (e.g., an administrator or other type of user) may create application probes based on a particular application to probe, time to run the probe, frequency of running the probe, and a user account for conducting the probes.

In some implementations, the probes may be created using, e.g., the above-noted Director User Interface (UI) or any other management console UI 402. In some implementations, the probe configurations in the management console UI may be listed, viewed, edited, and deleted. The configurations may include, e.g., the above-noted storefront or other enterprise application 406 store URL to launch the applications to be probed, which may also include authenticating user account credentials (e.g., username, password, etc.) used when launching the applications and running the probe. Generally, the list of applications available for the administrator to probe may be shown (via the UI of the above-noted management console 402), and the administrator may select one or more applications that are to be probed using the credentials. In some implementations, the selection of applications may be done automatically by, e.g., selecting all available applications. The above-noted storefront or other enterprise application 406 may be used to enumerate all the available applications and schedule the probe for all applications. If the probe is to be scheduled for a specific application, the administrator (or other user) may select the required applications manually. The administrator may further select the time at which the probe is run (e.g., on an hourly granularity), and may opt-in for sending/receiving email or other notifications with a list of email addresses to be notified if there is something to report (e.g., if the application launch fails or if monitored thresholds have been surpassed), discussed more below.

In some implementations, the administrator (or any other user) may further select the list of endpoints (e.g., URLs or other address of a published resource) on which this configuration is to be run (e.g., the endpoint may be listed per heartbeat received). For example, probe process 10 may expose a JSON API (or another API) to receive a heartbeat or other signal (e.g., a periodic signal generated by hardware or software to indicate normal operation or to synchronize other parts of a computer system) from each probe. The first heartbeat may be used to create a new probe endpoint in the database and may assume that the endpoint name as being unique to coordinate results of all heartbeats directed to the endpoint name. The probe endpoint and the last heartbeat may be stored in the monitoring database (e.g., Monitor DB 408 shown in a diagrammatic view of probe environment 400 in the example implementation of FIG. 4).

In some implementations, at block 302, the client device 12 may (e.g., via probe process 10) receive data indicative of the at least one attribute of the application in response to the application being monitored by the application probe. For example, the client device may run the application probe (e.g., within probe service 416) for one or more applications, also referred to as published resources (e.g., a software as a service (SaaS) application, a virtual application, a published application, and a hosted shared desktop, etc.). For example, the application probe may be run at probe service 416 on probe endpoint 412 machine (computing device). In some implementations, probe endpoint 412 may be installed as an operating system (OS) service receiver 414. The above-noted StoreFront Software Development Kit (SDK) (or other enterprise application 406 store) may be used to ensure the application is available, and once an application is selected, a file (e.g., an Independent Client Architecture or (ICA) file or other similar file type) may be used to invoke the particular published resource of the probe endpoint. Using the ICA Client Object Software Development Kit (ICOSDK) 410 and probe service 416, the particular published resource, such as an SaaS or virtual application, may be launched. In some implementations, the SaaS application (or other published resource) may be launched on a secure browser\embedded browser. The created probes may be provided information on the point of failure (e.g., authentication failure and post authentication failure, such as whether or not any user action failed). In some implementations, probe process 10 may capture one or more packets from the above-noted ICOSDK to ensure the SaaS application has launched appropriately, and if no packet is received, a failure may be indicated, as discussed below. In some implementations, a monitoring database (e.g., Monitoring DB 408 shown in FIG. 4) may store probe results (including historical probe results), probe configurations, and probe endpoint details. It will be appreciated that the running of the probe may support single sign on authentication, and may also support multi-factor sign on authentication (e.g., by adding the support for AuthKeyGenerator while configuring the probe).

At optional block 310, the client device (e.g., via probe process 10) may verify for the application one or more user based actions of a user, which include determining whether the user is able to be authenticated to access the SaaS application (or other published resources). For example, as noted above, probe process 10 may fetch and run the ICA file. An ICA file may be fetched for application launch as per the above-noted probe configurations in the management console UI. In the example, fetching the ICA file may focus on the username and password data store, which may then be used to authenticate the user to access the application or other published resource (e.g., the SaaS or virtual application). If authentication fails, probe process 10 may receive the following example and non-limiting errors: storefront not reachable, authentication failed, application enumeration failed, ICA file not downloaded. As per the fetched probe configuration, the probes may be executed at the specified time. In some implementations, if there are multiple applications to be probed at the same time, the probing may occur sequentially (e.g., one after another). In some implementations, the probing may occur in parallel.

After launching the application by loading the above-noted ICA file, probe process 10 may wait for one or more events to occur (e.g., an OnConnect event is received) indicating that the application launch will be reported as “Pass” or if an OnConnect event is not received (e.g., within 90 seconds or other configurable time period) or if an OnConnectFailed event is received indicating that the application launch will be reported as “Fail” with a time out error in the logs. Probe process 10 may then logoff of the application. The result of the probe may be saved in memory, e.g., until it is sent to the above-noted management console through the exposed JSON API.

In some implementations, the one or more user based actions of the user being verified may include determining whether the user is able to navigate through the application or other published resources after authentication. For instance, assume for example purposes only that the user credentials enable the probe to authenticate the user to access the SaaS (or virtual) application. Probe process 10 may then determine whether the user is capable of then navigating through the SaaS application. This navigation may include, e.g., accessing requested files, navigating through various aspects of the SaaS application, selecting links, mouse clicks, keyboard strokes, etc. which may be captured and replayed on the probed applications.

In some implementations, at block 304, the client device may (e.g., via probe process 10) determine a value for the at least one attribute based upon, at least in part, the received data. For example, the client device may monitor one or more attributes of the application accessible via the client device while the application probe is running. For example, at least one of the values for the attributes may include logon duration (e.g., how long it took the user account to logon to the example SaaS or virtual application), application launch duration (e.g., how long it took the SaaS or virtual application to successfully launch), and round-trip time/latency (e.g., how long it took the SaaS application to respond to a request from the user account). The logon duration, ICA Round Trip Time metrics may be retrieved to show the information. The logon duration may be retrieved once for every application launch, and the ICA round trip time may be retrieved periodically (e.g., every 5 minutes).

In some implementations, at block 306, the client device may (e.g., via probe process 10) compare the determined value with a threshold to identify an issue with the application. For example, the client device may determine one or more values for the one or more attributes based upon, at least in part, monitoring the one or more attributes (e.g., while the probe may be running during one of a loaded environment and an unloaded environment). For example, the probe may use the monitored attributes to determine the values of the above-noted monitored attributes (e.g., for one or more of logon duration, application launch duration, round-trip time/latency) in an unloaded environment (e.g., off-hours on a weekend when traffic may be low) or in a peak loaded environment (e.g., late morning on a Tuesday when traffic may be at its highest), to help better understand the “normal” values for the environment and help gauge alert threshold values. This may help the administrator assess the real application health and accordingly, in case of failures or lack of estimated resource availability, enable the administrator to be alerted and take proactive measures to fix problems or minimize disruption to the client. For example, if the user comes in at 8 am and the probe runs the test at 4 am, the administrator may find out about any problems earlier than any user may actually experience them, to provide the administrator with some time to try to remedy and contain any disruption. As an example, in some implementations, the application launch times may be modeled using the historical data. Using this model, the threshold values for the example logon duration, application launch duration, and round-trip time/latency may be determined for that environment (e.g., automatically by the model or manually by the administrator). For instance, if the application launch time deviates too much from the modeled data (e.g., by 10 seconds), then an alert may be triggered. As an example, if the application has been launching within 5 seconds in the past one month, and now it is taking 15 seconds (e.g., 10 seconds past the threshold), then an alert may be generated. Assume for example purposes only that the above example is during an unloaded environment (i.e., less expected traffic). The alert threshold values may differ during a loaded environment, even if the values are the same. For instance, in a loaded environment when more traffic is expected, it may be normal to have a 15 second application launch time, which would not trigger generation of an alert. However, if the application has been launching within 15 seconds in the past one month during a loaded environment, and now it is taking 25 seconds (e.g., 10 seconds past the threshold), then an alert may be generated. In some implementations, logon duration, application launch time, or any other attribute value for a given user/delivery group/site may be base lined over a period of time (e.g., a simple average). This base line may then be fed to some anomaly detection algorithm to determine and identify (e.g., flag) abnormal values. Other example issues that may be determined may similarly include, e.g., round-trip time/latency, whether authentication occurs (and/or how long it takes to occur) and whether or not post authentication user actions occur (e.g., such as mouse clicks and keyboard strokes) and/or how long they take to occur.

In some implementations, at block 308, the client device may (e.g., via probe process 10) provide an indication to a computing device in response to the comparison of the determined value with the threshold, so as to enable the computing device to modify operation of the application to address the issue. For instance, the client device may provide a report of the one or more attributes. For example, probe process 10 may generate and send a report (e.g., a notification or alert) of the monitored attributes, whether the applications were successful, if the applications failed, and/or if one of the above-noted threshold values has been reached. For instance, during insertion of a probe execution report, probe process 10 may send a report/notification (e.g., via email, text message, pop-up window, etc.) to all designated recipients selected by the administrator in the probe configuration. This may enable the administrator to review the report and find out about any problems earlier than any user may actually experience them, to provide the administrator with some time to try to remedy and contain any disruption.

In some implementations, probe process 10 may attempt to map any unmapped probe results (e.g., failures) with the existing connection failure records. The failures may be mapped with the connection failures using, e.g.:
The endpoint name (e.g., probe endpoint name),
Application launch time (e.g., connection start time),
Username (e.g., username of the probe configured user),
Probe PublishedName (e.g., PublishedName and BrowserName on the monitor data store in FIG. 4).

As noted above, probe process 10 may expose the JSON APIs for receiving the probe run results. Once the results data arrives, it may be stored in the monitor data store. In some implementations, the SaaS or virtual application health at high level may be displayed in an Application Dashboard (in the management console) per probe endpoint. The dashboard may include a report for all the application probe launches occurring within a configurable period of time (e.g., the last 7 days) with filtering and sorting capabilities. The report may consist of, e.g., application or published resource name, time of launch, machine on which the application was launched, status (e.g., pass\fail), failure type, probe endpoint name, and/or an application launch detailed log (e.g., the result of the probes executed in different stages, such as StoreFront reachability, authentication, application enumeration, ICA download, ICA launch, etc. and the time spent at each stage). In some implementations, the heartbeat data may also be sent to the above-noted management console (e.g., every 10 minutes). The heartbeat data may include, e.g., the endpoint name, and the version of the probe installer.

In some implementations, the above-noted probe may be either “headless” or “non-headless”. In headless mode, the probe may be launched and the UI is not seen. In non-headless mode, the UI may be shown. The headless mode may be beneficial, as the application's UI is hidden (e.g., for security purposes).

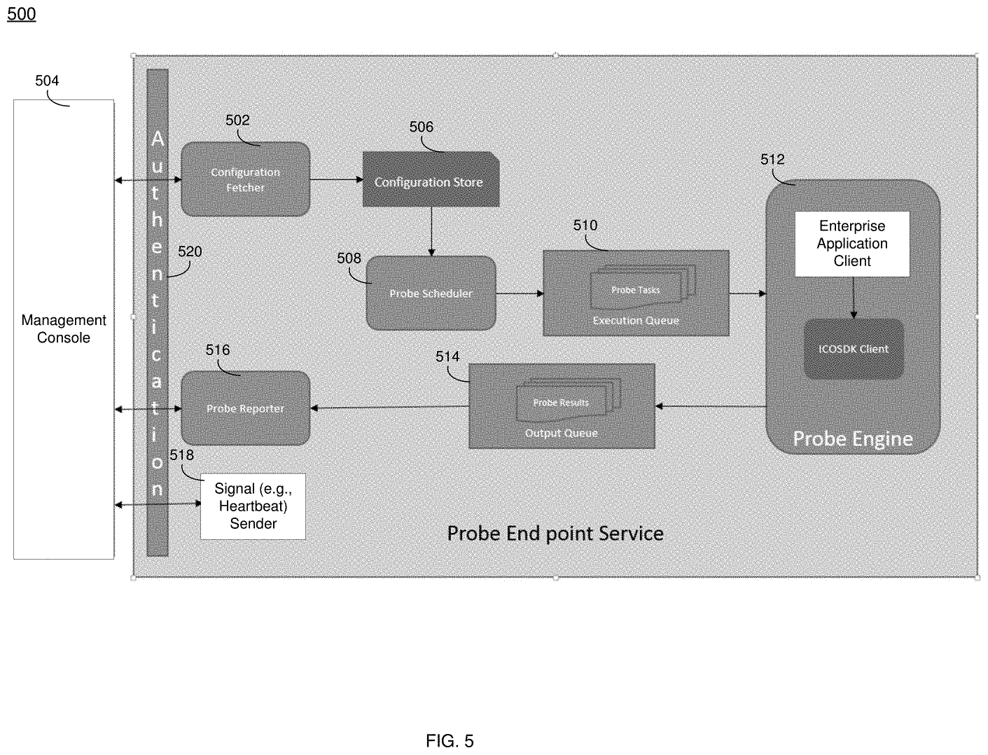

Referring also at least to the example implementation of FIG. 5, an example diagrammatic view of a high level design of a probe endpoint 500 is shown. In the example, the probe endpoint may be installed as an operating system service and, as noted above, the configurations may be editable by the administrators of the machine where the service is running. Example components of the probe endpoint (associated with probe process 10) shown in FIG. 5 may include, e.g.:

Probe configuration fetcher 502: fetches the configuration from the management console periodically (e.g., every 6 hours) or when the probe is run and called to update the configuration store where the probe configurations are located.

Management console 504 executed on a remote computing device, such as client electronic device 24: the UI where the probe configurations may be listed, viewed, edited, and deleted. It is these probe configurations that are fetched by probe configuration fetcher 502.

Configuration Store 506: stores the above-noted probe configurations from the management console U. The configurations may include, e.g., the storefront or other enterprise application store URL to launch the applications to be probed, which may also include authenticating user account credentials (e.g., username, password, etc.) used when launching the applications and running the probe, time and frequency to run the probes, notification settings, etc.

Probe scheduler 508: reads the configurations from the configuration store and puts the probe tasks in a queue at the specified time. The application launches may be sequential and each task may correspond to one application launch.

Probe execution queue 510: The queue encompasses the application launches scheduled by probe scheduler 508.

Probe engine 512: encompasses the StoreFront client and ICOSDK client: Actual application probing may occur in the probe engine as the probe endpoint (e.g., probe endpoint 412 from FIG. 4) that may fetch the above-noted ICA file and launch the application.

Probe result queue 514 (output queue): once the application or other published resource launch is complete, the probe engine may store the application or other published resource launch results with logs to the output queue.

Probe reporter 516: This may format the message as needed by management console 504. It may message the report with other details such as the endpoint name, user name, etc., before sending it to management console 504.

Signal (e.g., heartbeat) sender 518: may be a separate entity that may be sending the heartbeat periodically to the management console.

Authentication 520: may enable both cloud and on-premises authentication.

It will be appreciated that while the present disclosure describes an administrator, any user may also achieve the benefits of the present disclosure without departing from the scope of the present disclosure. As such, the use of an administrator should be taken as example only.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code or machine code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), a body area network BAN), a personal area network (PAN), a metropolitan area network (MAN), etc., or the connection may be made to an external computer (for example, through the internet using an Internet Service Provider). In some implementations, electronic circuitry including, for example, programmable logic circuitry, an application specific integrated circuit (ASIC), field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A method comprising:
creating, by a client device, an application probe, the application probe configured to monitor at least one attribute of an application accessible via the client device;
receiving, by the client device, data indicative of the at least one attribute of the application in response to the application being monitored by the application probe;
determining, by the client device, a value for the at least one attribute based upon, at least in part, the received data;
comparing, by the client device, the determined value with a threshold to identify an issue with the application; and
providing, by the client device, an indication to a computing device in response to the comparison of the determined value with the threshold, so as to enable the computing device to modify operation of the application to address the issue.

2. The method of claim 1 wherein the application is one of a software as a service (SaaS) application, a virtual application, a published application, and a hosted shared desktop.

3. The method of claim 1 wherein the at least one attribute includes one or more of logon duration, application launch duration, and latency.

4. The method of claim 1 wherein the application is accessible by the client device through one of a loaded environment and an unloaded environment.

5. The method of claim 1 further comprising verifying one or more user based actions of a user for the application based upon the received data.

6. The method of claim 5 wherein the one or more user based actions includes authenticating the user to access the application with the application.

7. The method of claim 5 wherein the one or more user based actions includes navigating through the application.

8. A computer program product residing on a computer readable storage medium having a plurality of instructions stored thereon which, when executed by one or more processors, causes the one or more processors to perform operations comprising:
creating, by a client device, an application probe, the application probe configured to monitor at least one attribute of an application accessible via the client device;
receiving, by the client device, data indicative of the at least one attribute of the application in response to the application being monitored by the application probe;
determining, by the client device, a value for the at least one attribute based upon, at least in part, the received data;
comparing, by the client device, the determined value with a threshold to identify an issue with the application; and
providing, by the client device, an indication to a computing device in response to the comparison of the determined value with the threshold, so as to enable the computing device to modify operation of the application to address the issue.

9. The computer program product of claim 8 wherein the application is one of a software as a service (SaaS) application, a virtual application, a published application, and a hosted shared desktop.

10. The computer program product of claim 8 wherein the at least one attribute includes one or more of logon duration, application launch duration, and latency.

11. The computer program product of claim 8 wherein the application is accessible by the client device through one of a loaded environment and an unloaded environment.

12. The computer program product of claim 8 further comprising verifying one or more user based actions of a user for the application based upon the received data.

13. The computer program product of claim 12 wherein the one or more user based actions includes authenticating the user to access the application with the application.

14. The computer program product of claim 12 wherein the one or more user based actions includes navigating through the application.

15. A computing system comprising:
a memory; and
at least one processor in communication with the memory, the at least one processor configured to:
create, by a client device, an application probe, the application probe configured to monitor at least one attribute of an application accessible via the client device;
receive, by the client device, data indicative of the at least one attribute of the application in response to the application being monitored by the application probe;
determine, by the client device, a value for the at least one attribute based upon, at least in part, the received data;
compare, by the client device, the determined value with a threshold to identify an issue with the application; and
provide, by the client device, an indication to a computing device in response to the comparison of the determined value with the threshold, so as to enable the computing device to modify operation of the application to address the issue.

16. The computing system of claim 15 wherein the application is one of a software as a service (SaaS) application, a virtual application, a published application, and a hosted shared desktop.

17. The computing system of claim 15 wherein the at least one attribute includes one or more of logon duration, application launch duration, and latency.

18. The computing system of claim 15 wherein the application is accessible by the client device through one of a loaded environment and an unloaded environment.

19. The computing system of claim 15 further comprising verifying one or more user based actions of a user for the application based upon the received data.

20. The computing system of claim 19 wherein the one or more user based actions includes one or more of:
authenticating the user to access the application; and
navigating through the application.
